(19) United States
(12) Patent Application Publication
(10) Pub. No.: US 2026/0290776 A1
(43) Pub. Date: Sep. 24, 2026

(54) METHOD OF COUNTING NANOPARTICLE TAGS IN SOLID SAMPLES

(71) Applicant: MASARYKOVA UNIVERZITA, Brno (CZ)

(72) Inventors: Jan PREISLER, Brno (CZ); Marek STIBOREK, Brno (CZ); Vilem SVOJANOVSKY, Brno (CZ); Viktor KANICKY, Brno (CZ)

(21) Appl. No.: 18/874,067

(22) PCT Filed: Jun. 9, 2023
(86) PCT No.: PCT/CZ2023/050031

§ 371 Date: Dec. 11, 2024

(30) Foreign Application Priority Data
Jun. 20, 2022 (EP) 22179809.3

(51) Int. Cl. H01J 49/04; G01N 15/10; H01J 49/00; H01J 49/10

(52) U.S. Cl. CPC H01J 49/0463; G01N 15/10; H01J 49/0031; H01J 49/105; G01N 2015/1024

(57) ABSTRACT

A method of counting inorganic nanoparticle tags in a sample uses laser ablation inductively coupled plasma mass spectrometry (LA ICP MS) and requires the steps of: a) providing a sample containing inorganic nanoparticle tags, the sample having at least one absorbing component capable of absorbing the energy of a laser at least one predetermined wavelength, b) irradiating a spot in the sample by a laser emitting at the at least one predetermined wavelength, thereby exciting and ablating the absorbing component on the illuminated spot, thereby causing desorption of the inorganic nanoparticle tag(s) which are present in the irradiated spot without disintegrating the inorganic nanoparticle tag(s), c) transferring the desorbed inorganic nanoparticle tag(s) into an ICP torch, subjecting it to inductively coupled plasma mass spectrometry, and detecting spike(s) of the individual inorganic nanoparticle tag(s); and d) optionally repeating steps b) and c).

### FIELD OF ART

The present invention relates to a method of counting nanoparticle tags in solid samples. The invention allows using an unlimited number of nanoparticle tags and/or an extremely sensitive detection of nanoparticles due to the generation of individual nanoparticles from biological tissues in an adapted laser ablation system allowing their sensitive detection and counting, using inductively coupled plasma mass spectrometry in single-particle mode.

### Background Art

Nanomaterials have a broad range of biomedical applications; among others, they are employed clinically in imaging, sensing, and drug delivery systems. This enormous potential of nanomaterials in diagnostic and therapeutic applications stands in a sharp contrast to a growing number of critical reports regarding their potential toxicity.

Among plentiful techniques for the determination of the total accumulation of inorganic nanomaterial in tissues, a few offer its detection at the single-cell level. One of them is confocal microscopy, an imaging technique based on sensitive fluorescent detection. It requires attachment of a suitable fluorophore or a nanoparticle with intrinsic fluorescence. Label-free imaging techniques of particles, such as electron microscopy and tomography suffer from low throughput. Inductively coupled plasma mass spectrometry (ICP MS) is a powerful tool for trace and ultra-trace analysis, which also provides information about the chemical composition of the nanomaterial. When coupled with laser ablation (LA), it can generate distribution maps of one or more inorganic elements present in atomic, molecular, or nanoparticle forms in biological material. However, to provide quantitative information about an element, thousands or millions of atoms of the element must be present in the ablated material. Using LA ICP mass spectrometry imaging (MSI), nanoparticles can be imaged on cellular or even subcellular levels with the detection limits of 20 Ag nanoparticles (50 nm) or 190 for 25-nm Au nanoparticles (Drescher, D.; Giesen, C.; Traub, H.; Panne, U.; Kneipp, J.; Jakubowski, N., Analytical Chemistry 2012, 84 (22), 9684-9688).

The LA ICP MSI method has been developed for biological sample imaging, in which polymeric metal chelates tagged to antibodies are employed for selective LA ICP MS mapping and quantifications of multiple targets in cells (Giesen, C.; Wang, H. A. O.; Schapiro, D.; Zivanovic, N.; Jacobs, A.; Hattendorf, B.; Schuffler, P. J.; Grolimund, D.; Buhmann, J. M.; Brandt, S.; Varga, Z.; Wild, P. J.; Gunther, D.; Bodenmiller, B., Nature Methods 2014, 11 (4), 417.) Here, an increase in the number of metal atoms bound to each antibody through the use of nanoparticles of polymeric metal chelates substantially boosts sensitivity. LA ICP MSI is sometimes referred to as imaging mass cytometry as it adapts laser ablation to mass cytometry to apply it for mapping of tissue sections; it relies on the staining of tissues with panels of metal-tagged antibodies. In principle, it permits highly multiplexed use of up to ~100 tags with different metal isotopes for simultaneous detection of multiple analytes in tissue. Thus, in combination with ICP MS, nanoparticles represent tags which overcome limitations of fluorescent tags, cell autofluorescence and spectral overlap of fluorophores that limits tag number to ~10.

More recently, gold nanoclusters were bioconjugated to specific antibody probes. (Cruz-Alonso, M.; Fernandez, B.; Alvarez, L.; Gonzalez-Iglesias, H.; Traub, H.; Jakubowski, N.; Pereiro, R. Microchimica Acta 2018, 185 (64)). In another approach, silica-coated NaHoF₄ NPs were shown to improve the detection ability of rare cellular markers or cell types by more than one order of magnitude compared to the polymeric metal chelate tags. (Pichaandi, J.; Zhao, G. Y.; Bouzekri, A.; Lu, E.; Ornatsky, O.; Baranov, V.; Nitz, M.; Winnik, M. A. Chemical Science 2019, 10 (10), 2965-2974). Thus, a small tag with maximal number of metal atoms per tag can yield similar amplification as larger polymeric metal chelate.

The speed and sensitivity of LA ICP MSI have been greatly improved due to the development of ablation cells with washout times below 10 ms. (Gundlach-Graham, A.; Gunther, D., Analytical and Bioanalytical Chemistry 2016, 408 (11), 2687-2695; Van Malderen, S. J. M.; Van Acker, T.; Vanhaecke, F., Analytical Chemistry 2020, 92 (8), 5756-5764).

WO 2016090356 exploits the LA ICP MSI method for biological sample imaging using UV lasers in the ablation step. The energy of the laser causes the formation of a plume from the nanoparticle tag, the plume formation is presented as desirable. The plume is then subjected to ICP MS. However, the signals of individual nanoparticle tags may be blurred together and do not provide characteristic spikes for each individual nanoparticle. Such an embodiment still only allows one to determine the presence and amount of a metallic element, thereby limiting the maximum number of nanoparticle tags that can be used.

Single-particle (SP) ICP MS is a method offering a relatively simple and straightforward measurement of nanoparticles at a single particle level. (Laborda, F.; Bolea, E.; Jimenez-Lamana, J., Analytical Chemistry 2014, 86 (5), 2270-2278.) The disintegration of nanoparticles delivered to plasma produces sub-millisecond signal spikes; the number of the spikes and the spike intensity histogram provide direct information about nanoparticle concentration and size distribution. Employment of a mass analyzer allows rapid, (quasi)simultaneous detection of multiple isotopes, i.e., the content of an isotope or content and ratio of isotopes/elements, in individual single isotope or multi-isotopic/multi-elemental nanoparticles, respectively, can be determined. Nanoparticles are introduced to ICP MS in the form of diluted suspensions using nebulizers or microdroplet generators.

Using LA SP ICP MS with UV lasers, individual nanoparticles were detected from plant tissues recently (Yamashita, S.; Yoshikuni, Y.; Obayashi, H.; Suzuki, T.; Green, D.; Hirata, T., Analytical Chemistry 2019, 91 (7), 4544-4551; Metarapi, D.; Sala, M.; Vogel-Mikus, K.; Selih, V. S.; van Elteren, J. T., Analytical Chemistry 2019, 91 (9), 6200-6205). These nanoparticles were not used as tags, they were merely accumulated by the plants. Therefore, they were scattered within the tissues, not immobilized or deposited on the tissue surface. The data suggest low detection efficiency as well as substantial disintegration of the nanoparticles. Also, a significant portion of nanoparticles was completely disintegrated and could not be detected.

The object of the present invention is to develop a method of counting nanoparticle tags on planar samples such as biological samples (e.g., tissue sections) or biological samples immobilized on supports, allowing to use an effectively unlimited number of nanoparticle tags, and allowing to detect nanoparticle tags even when they are present in very low numbers.

### Disclosure of the Invention

The present invention effectively prevents the disintegration of inorganic nanoparticles during the ablation of samples labeled with nanoparticle tags, thereby allowing a single inorganic nanoparticle to be subjected to ICP MS, and its characteristic spike(s) to be obtained. Due to a straightforward distinguishing spike signal from the background, nanoparticles can be directly counted. Furthermore, in addition to inorganic nanoparticle tags consisting of a metal, a metal salt, or a metal oxide, the nanoparticle tags may also consist of a mixture of components, e.g., of a mixture of at least two metals, metal salts, or metal oxides or a mixture of at least two isotopes of one metal in the metal, metal salt or metal oxide nanoparticle. Thus, the method allows the determination of the presence and amounts of a virtually unlimited number of types of inorganic nanoparticle tags present in a sample, including nanoparticles comprising mixtures of the same metals/metal salts/metal oxides/isotopes and differing only in their ratios. Thus, instead of using only, e.g., Au nanoparticles as one type of inorganic nanoparticle tags, and Ag nanoparticles as another type of inorganic nanoparticle tags, the method of the present invention also allows to use inorganic nanoparticle tags comprising both Au and Ag atoms in one nanoparticle, in various ratios (each type of inorganic nanoparticle tag contains a different ratio Au/Ag), or comprising two Au isotopes, in various ratios. This greatly improves the versatility of labeled sample imaging and increases in a combinatorial manner the number of usable inorganic nanoparticle tags.

In the method of the invention, the detection of inorganic nanoparticles at a single-particle level is enabled due to the effective prevention of inorganic nanoparticle disintegration in the ablation cell which is due to the use of a suitable laser wavelength, typically of an IR laser, the radiation of which is strongly absorbed by constituents of organic samples, such as water and organic molecules. The wavelength range is preferably 2 to 10 μm; a distinctive example is 2940 nm corresponding to a strong absorption band of water.

Alternatively, an auxiliary absorbing component absorbing at the wavelength of the ablation laser is added onto the sample. In this case, the laser wavelength is not limited to the IR region, but can be extended to NIR, Vis, or UV. Absorption of the auxiliarly absorbing component, which is typically an organic substance, is much stronger than that of inorganic nanoparticles. The previously known LA ICP MS methods of imaging biological samples stained with nanoparticle tags typically employed pulsed UV lasers and did not employ any auxiliary absorbing component—this arrangement resulted in a complete or partial disintegration of the nanoparticles and the formation of a plume in the laser ablation chamber. The plumes generated from the disintegration of individual nanoparticles are blurred during their transport to the plasma torch and do not produce characteristic sharp spikes, thus the nanoparticles cannot be counted, i.e., the detection of the location of individual particles is impossible.

The nanoparticle tags used in the present invention are inorganic nanoparticle tags, consisting of at least one metal and/or at least one metal salt and/or at least one metal oxide. The nanoparticle tags may contain one or more isotopes of a metal (in the form of metal, metal salt, or metal oxide). The nanoparticles thus do not contain any organic matter, such as organic ligands or chelating ligands, which would increase the risk of formation of a plume and blurring of the signal.

Using the method of the invention, the single-particle spikes can be easily distinguished from a baseline or an elevated baseline or a broad spike generated by sample ablation in the laser ablation chamber due to, e.g., a certain nonzero endogenous level of the monitored isotope in the imaged sample. This means that the broadening of the plumes generated by the ablation of samples, not nanoparticles, does not prevent the accurate counting of nanoparticles.

The present invention thus provides a method of counting inorganic nanoparticle tags in a sample, using laser ablation inductively coupled plasma mass spectrometry (LA ICP MS), comprising the steps of:
a) providing a sample containing inorganic nanoparticle tags, said sample having at least one absorbing component capable of absorbing the energy of a laser beam at least one predetermined wavelength,
b) irradiating a spot in the sample by a laser beam emitted by a laser emitting at the at least one predetermined wavelength, thereby exciting and ablating the absorbing component on the illuminated spot, thereby causing desorption of the inorganic nanoparticle tag(s) which are present in the irradiated spot without disintegrating the inorganic nanoparticle tag(s),
c) transferring the desorbed intact inorganic nanoparticle tag(s) into an ICP torch, subjecting it to inductively coupled plasma mass spectrometry, and detecting spike(s) of the individual inorganic nanoparticle tag(s);
d) optionally repeating steps b) and c).

In the present method, at all predetermined wavelengths the inorganic nanoparticle tag(s) do not absorb so that they would decompose and form a plume, instead, they are desorbed due to ablation of the absorbing component. This is ensured by using IR wavelengths, or by using an auxiliary absorbing component together with UV, Vis, NIR, or IR wavelengths.

In some preferred embodiments, the at least one predetermined wavelength is in the range of 400 nm to 50 μm, more preferably 700 nm to 50 μm.

In some preferred embodiments, the at least one predetermined wavelength is in the range of 157 nm to 50 μm, more preferably 193 nm to 50 μm, or from 157 nm to 1500 nm, and an auxiliary absorbing component absorbing at the predetermined wavelength is used.

### Step A

The sample containing inorganic nanoparticle tags may be a sample doped with inorganic nanoparticle tags or labeled or stained by inorganic nanoparticle tags. The inorganic nanoparticle tags may act as labels or tags bound or attached to one or more specific components of the sample. The inorganic nanoparticle tags may be selectively bound to predetermined components (target components) of the sample, for example via a selective probe targeting the corresponding predetermined component.

Methods of binding or attaching inorganic nanoparticle tags to selective probes, which are typically organic molecules or biomolecules, such as peptides, proteins, glycoproteins, polysaccharides, antibodies, nanobodies, aptamers, nucleic acids, ligands, or chelating agents, are known in the art.

The sample may contain one type of inorganic nanoparticle tags or a plurality of types of inorganic nanoparticle tags. The term “type of inorganic nanoparticle tags” refers to a specific composition of inorganic nanoparticle tags. The nanoparticle tags may be composed of one metal and/or one metal salt and/or metal oxide, or of a mixture of metals and/or metal salts and/or metal oxides. This allows to prepare a large number of nanoparticle tags, as each ratio of metals or metal salt or metal oxides or metal isotopes in the mixture represents a different type of inorganic nanoparticle tags, and can be distinguished from other types of inorganic nanoparticle tags by means of the present invention due to the fact that each nanoparticle tag gives a sharp spike due to the fact that it does not disintegrate before reaching the ICP torch.

The metals are preferably transition or inner transition metals and mixtures thereof; more preferably transition or inner transition metals having atomic mass of 80 or more, and mixtures thereof. Inner transition metals are lanthanides and actinides.

Metal salts are salts of metals, in particular transition or inner transition metals, with anions. The anions are preferably anions of inorganic acids, for example, halogenides. In some salts, the transition or inner transition metals form part of complex anions. The metal salts are preferably salts, preferably halogenides (in particular fluorides) or sulfides, or complex salts of lanthanides (Ln), such as NaLnF₄.

The metal oxides are preferably oxides of lanthanides or transition metals, such as Ln₂O₃, CeO₂, ZrO₂, HfO₂, CoO, NiO, MoO₃, WO₃.

The sample is typically a biological sample or a sample of organic molecules or biomolecules. It is preferred when the sample is a planar sample (i.e., having one dimension at least 10 times, preferably at least 100 times, smaller than the other dimensions). The sample may be, for example, a tissue section, or a planar carrier (e.g., a plastic carrier) with biomolecules or macromolecules applied or coated thereon.

The absorbing component, i.e., the component absorbing at least one predetermined wavelength of the laser beam, may be a component that is present in the sample, or it can be an auxiliary absorbing component added to the sample before, simultaneously with, or after application of the inorganic nanoparticle tags.

In some embodiments, the (auxiliary) absorbing component may be a planar carrier of the sample.

The auxiliary absorbing component may be, for example, a dye or a polymer. Examples of suitable polymers are nitrocellulose, cellulose, gelatin, polystyrene, polyethylene terephthalate glycol, polyethylene terephthalate, polyacrylates, and polycarbonates.

Either an absorbing component naturally present in the sample is capable of absorbing the energy of the laser irradiation, or an auxiliary absorbing component, e.g., a dye or a polymer, may be provided. The sample may be doped with the auxiliary absorbing component, or the auxiliary absorbing component may be applied on top of the sample, e.g., as a layer. The absorbing polymer may preferably be provided in the form of a polymeric support (e.g., a slide) on which the sample is immobilized.

The inorganic nanoparticle tags are applied on the sample or polymeric support in the form in which they are attached to selective probes (such as antibodies against target components, ligands of target components, or inhibitors of target components). Target components are the components in the sample which are to be labeled, tagged, or stained. The selective probe ensures that the inorganic nanoparticle tag is selectively bound or attached to the target component, thus allowing for the detection of the presence and amount (and location in the sample) or absence of the target component in the sample.

### Step B

The sample comprising the inorganic nanoparticle tags is irradiated by a laser. The laser emits radiation having the predetermined wavelength. The laser is focused on a spot. The minimum size of the spot is determined by the wavelength of the laser. The maximum size of the spot is determined by the required scanning quality, by the total area of the sample, and/or by the application. In the case of imaging applications, inorganic nanoparticle tags are counted on individual pixels of the sample (typically biological tissue) to construct an image of the spatial distribution of a predetermined component in the sample. In the case of quantitation applications, only the total number of inorganic nanoparticle tags on the sample (typically polymer) is determined. For example, the spot diameter may be in the range of 0.5 to 50 μm when the laser is scanning over the surface of the sample—for imaging applications. The spot diameter may be in the range of 10 to 500 μm when the laser is irradiating the whole area of the sample (or the whole area of interest in the sample)—for quantitation applications. The laser-emitted radiation energy is absorbed at least by the absorbing component on the illuminated spot. The absorption of the energy causes the excitation and ablation of at least the absorbing component, which in turn causes desorption of the inorganic nanoparticle tags. However, the inorganic nanoparticle tags are not ablated, disintegrated, and do not form a plume of atoms.

### Step C

The energy of the laser irradiation (laser beam) in the previous step is concentrated in the biological sample and it is sufficient to excite and ablate the sample, but it is not absorbed by the inorganic nanoparticle tags sufficiently to disintegrate the inorganic nanoparticle tag and to form a plume of the nanoparticle tag. The nanoparticle tag is transferred to the ICP torch without blurring and is measured in one characteristic spike.

The desorbed inorganic nanoparticle tags are then carried by the carrier gas towards the ICP torch. Due to the fact that the inorganic nanoparticle tags do not disintegrate before reaching the ICP torch, their signal is sharp and strong, with a good temporal resolution, i.e., with a typical pulse width within the range of 200 to 600 —s.

The signal spikes of the nanoparticle tags are measured by ICP MS and counted. Mass spectrometers include quadrupole mass filters or magnetic sectors that detect ions at only one mass-to-charge ratio (m/z) at a time, or time-of-flight and multi-collector mass spectrometers that can detect multiple types of ions having different m/z values simultaneously. The response of both types of mass spectrometers is fast enough to record the temporal profile of spikes produced by a nanoparticle tag for a single or multiple ions, respectively.

### Step D

Steps b) and c) may be repeated as needed. Usually, the laser beam scans or rasterizes over the surface of the sample which is turned towards the laser source. The scanning or rasterizing allows to prepare a two-dimensional analysis of the surface of the sample and to determine the location and distribution of the target components based on the presence and/or amounts of the inorganic nanoparticle tags bound or attached to the target components.

By repeating the steps b) and c), the laser is scanning over the sample, thereby irradiating the sample area of interest, counting all nanoparticle tags on the sample, and optionally creating a spatial image of nanoparticle tags on the sample.

The result of the analysis may preferably be further processed to obtain one or more of the following results: the total amount of target components in the sample, total amount of inorganic nanoparticle tags in the sample, spatial distribution of the target components in the assayed part of the sample, spatial distribution of the inorganic nanoparticle tags in the sample, 2D map (image) of the distribution of the target components in the assayed part of the sample, 2D map (image) of the inorganic nanoparticle tags in the sample, 3D map (image) of the distribution of the target components in the assayed part of the sample, 3D map (image) of the inorganic nanoparticle tags in the sample. This may be done for one target component, or for two or more target components simultaneously, by the use of several types of inorganic nanoparticle tags.

The method of the present invention may be embodied in a method of imaging the spatial distribution of at least one target component in a sample (or a part of a sample), wherein step d) is not optional. This is called herein “imaging applications”.

The method of the present invention may alternatively be embodied in a method of determining the total amount of at least one target component in a sample (or a part of a sample), wherein step d) is not performed. This is called herein “quantitation applications”.

The present invention may be performed using a device for counting inorganic nanoparticle tags in a sample labeled with inorganic nanoparticle tags using laser ablation inductively coupled plasma mass spectrometry (LA ICP MS), said system comprising:
a) an ablation chamber configured for receiving the sample and fitted with a laser configured to ablate the sample labeled with inorganic nanoparticle tags, said laser being preferably configured to emit radiation having the wavelength in the range of 157 nm to 50 μm;
b) an inductively coupled plasma torch connected with the ablation chamber and configured for receiving the excited and ablated components and the inorganic nanoparticle tag(s) from the ablation chamber,
c) a mass spectrometer connected with the inductively coupled plasma torch.

### DEFINITIONS

### Sample

The sample may be any organic sample. Preferably, the sample is a biological sample, such as a sample of tissue, or a plurality of cells. More preferably, the sample is a biological tissue, biological tissue section, 2D or 3D cell cultures, spots of cell suspension on a support, single cells on a support.

However, the sample may also be an organic support with immobilized proteins, antibodies, nanobodies, aptamers, nucleic acids, inhibitors or ligands, or chelating agents known in the art. Examples of suitable support materials are polymers absorbing at the wavelength of the employed laser, e.g., nitrocellulose, cellulose, polystyrene, polyethylene terephthalate glycol, polyethylene terephthalate, polyacrylates, polycarbonates. The polymers may incorporate a modifier, e.g., carbon, to boost absorption at the laser wavelength.

Before the measurement, the sample is stained, labeled, or tagged with inorganic nanoparticle tags. Auxiliary absorbing component may be added to the sample, if needed.

### Inorganic Nanoparticle Tags

Nanoparticle tags are generally defined as particles having the size in the range of 1 to 1000 nm, preferably in the range of 1 to 100 nm. The nanoparticle size is measured by SEM, TEM, or by nebulizer ICP MS. The reference method is SEM.

The inorganic nanoparticle tags are introduced into the sample for the purpose of analysis, as nanoparticle tags. Therefore, the method of the invention is suitable for counting, determining of amount, or imaging of target components of a sample wherein the target components are labeled or selectively labeled by inorganic nanoparticle tags.

For imaging and bioassays, nanoparticle tags may be attached to selective probes such as proteins, antibodies, nanobodies, aptamers, nucleic acids, ligands, or chelating agents. A plurality of different inorganic nanoparticle tags having different atomic masses may be used for multiplex experiments with the inorganic nanoparticle tags. Inorganic nanoparticle tags containing a mixture of metals and/or metal salts and/or metal oxides or a mixture of isotopes of the same metal and/or metal salts and/or metal oxide, in known ratios, generate a specific m/z pattern in a mass spectrum which may be used for multiplex experiments with the nanoparticle tags.

The nanoparticle tags may preferably be made of transition metals, lanthanides or actinides, or salts of transition metals, lanthanides or actinides or oxides of transition metals, lanthanides or actinides, or of their mixtures, or of mixtures of metal isotopes or salts or oxides of metal isotopes. More preferably, the nanoparticle tags may contain transition metals such as gold, silver, platinum metals, or lanthanides. In some embodiments, the metals forming the nanoparticle tags may have atomic masses within the mass range 80-250.

### TARGET COMPONENTS

The target components may include, for example, chemical compounds; biochemical molecules, such as proteins, peptides, nucleic acids, (poly)saccharides; cell organelles; cells.

### Range of Laser Radiation

The laser range should be understood here as an electromagnetic radiation range extending from 157 nm to 50 μm, preferably 500 nm to 50 μm, even more preferably 1 to 3.5 μm. More preferably, near infra-red part of the IR range is used, i.e., 2940 nm or 1064 nm. The NIR range is advantageous as organic compounds consisting of relatively light atoms (C, H, N, O) absorb in the NIR region while nanoparticles, which preferably consist of relatively heavy metal atoms (atomic mass>80), do not absorb here. Thus, the organic components (e.g. absorbing components of the biological sample or auxiliary absorbing component(s)) are ablated while nanoparticles are not disintegrated.

Preferably, the laser pulses are absorbed directly by the biological sample (in a fresh, dried, or frozen state). The wavelength of the laser should match an absorption band of the sample, preferably in the near-infrared region; a typical example is the wavelength of 2.94 μm emitted by Er:YAG laser or 2.7-3.5 μm emitted by an optical parametric oscillator, which corresponds to stretch of the O—H bond. The use of lasers emitting at longer wavelengths of the infrared region is possible; however, the spatial resolution of imaging deteriorates significantly due to the diffraction limit.

In principle, all lasers can be used in combination with an auxiliary absorbing component that absorbs at the wavelength of the laser radiation. In some embodiments, Nd:YAG lasers (1064 nm) can be used. For analysis of biological samples without any added auxiliary absorbing component, laser-generated light that is being efficiently absorbed by the biological sample itself can be applied. The examples are Er:YAG lasers (2.94 μm) or optical parametric oscillators in the 2.7-3.5 μm range should be used; radiation at this wavelength is strongly absorbed by water as it corresponds to OH stretch band of water.

### Laser

Preferred are pulsed lasers with a typical pulse duration of 10 fs to 300 μs, preferably of 1 ns to 20 ns.

In comparison with the UV lasers used in the prior art LA ICP MS methods, the fluence of IR lasers may be increased above 10 J/cm² without disintegration of nanoparticles. The laser pulse must ablate the absorbing component in the sample, but not the nanoparticles, in the laser ablation chamber and thus it facilitates the transport of individual nanoparticles from the laser ablation chamber to the plasma (ICP) torch.

The typical laser repetition rate is 1-10 000 Hz, preferably 10-50 Hz. Very low repetition rates prolong the total experiment time. A repetition rate of more than 10 Hz allows imaging of typical tissue samples to be achieved in a reasonable time. On the other hand, at one laser pulse, possibly a few laser pulses per spot, the upper limit of the repetition rate is restricted by the washout time of the employed ablation chamber.

In imaging applications, laser repetition rate and movement of the sample target (laser beam scan) have to be adjusted according to the washout time of the ablation cell to allow accurate counting of nanoparticles desorbed from each pixel. Washout time of ablation cell 10 to 200 ms, preferably 20 to 100 ms, is adequate for accurate counting nanoparticles without coincidence of two or more nanoparticles while keeping the total imaging time reasonable. The typical focus size of the laser ranges from micrometers to tens of micrometers. For subcellular spatial resolution, the focus size should be as small as possible, ideally diffraction-limited. It should be noted here that for these applications, minimizing fractionating effects of the sample and achieving the ideal shape of the ablated crater is not critical as long as the fluence is kept low enough to avoid nanoparticle disintegration. Pixel size does not have to necessarily match the spot size; beam overlapping resulting from the spot size being larger than the pixel size can be used to improve spatial resolution.

In quantitation applications, the time for irradiation of the sample, or the part of interest of the sample, is adjusted according to the anticipated number of detected nanoparticles. One should prevent too high frequency of the desorbed particles which would result in particle coincidence, i.e., the arrival of two or more particles to the plasma torch at the same time. Again, on the other hand, a very low laser repetition rate and slow target movement (laser beam scan) prolong the total experiment time. In the most sensitive experiments with the anticipated number of detected particles below 1000, the total analysis time should be minimized by maximizing the laser spot size, speed of target movement (laser beam scan), and laser repetition rate. At the same time, the entire sample area should be irradiated at a specific laser fluence to detect all nanoparticles in that area.

### Auxiliary Absorbing Component

The auxiliary absorbing component is used when there is no suitable absorbing component present in the sample which could sufficiently absorb the used laser radiation. Thus, the auxiliary absorbing component should be selected so that it absorbs at the wavelength of the used laser.

Typically, the auxiliary absorbing component may be selected from organic dyes, suspensions of graphite and/or metal, and polymers. The organic dyes may include cyanines, indoles, dienylidens, rhodamines, fluoresceins, coumarins. The polymers may include polyethylene terephthalate glycol, polyethylene terephthalate, polystyrene, polyacrylates, polycarbonates, nitrocellulose, and cellulose. The polymers may incorporate modifiers, e.g., carbon, to boost absorption at a particular wavelength. The polymers may preferably be in the form of a slide on which the sample is placed. An example of an auxiliary absorbing component is IR 1050, 1-butyl-2-[2-[3-[(1-butyl-6-chlorobenz[cd]indol-2(1H)-ylidene)ethylidene]-2-chloro-5-methyl-1-cyclohexen -1-yl]ethenyl]-6-chlorobenz[cd]indolium tetrafluoroborate.

The selection of the auxiliary absorbing compound(s) as well as its/their concentration, solvent, and deposition method of the auxiliary absorbing compound solution or suspension is optimized for the given laser wavelength with the aim of elimination of disintegration of nanoparticles. For example, gold nanoparticles with diameters below 100 nm do not absorb significantly above 700 nm. Employment of a 1064 nm Nd: YAG laser and a dye IR1061 strongly absorbing at the laser wavelength allows the generation of intact nanoparticles. Some nanoparticles exhibit low absorption even in the UV region; for example, silver nanoparticles do not absorb strongly at ~320 nm and can be desorbed in the presence of a UV absorbing dye using a 337 nm nitrogen or 349 nm Nd:YLF(3xf) laser.

### System for Nanoparticle Counting

The system preferably comprises a laser such as a pulsed laser; an ablation chamber typically containing a stage, an arrangement of one or more lenses (e.g., a beam expander and an aspheric lens for beam focusing) and/or one or more apertures, attenuator, beam shaping optics and an optional shutter located between the laser and the stage in the ablation chamber; optionally a camera system for sample visualization; an inductively coupled plasma torch; and a mass spectrometer. The system is preferably adapted to ablate samples, preferably biological samples (e.g., tissue sections, 2D or 3D cell cultures) or biological samples immobilized on supports on the stage by a focused laser beam.

### Laser Ablation Chamber

All types of laser ablation chambers may be used; laser ablation chambers with rapid washout (washout time on the order of 10 to 200 ms) are preferred for shortening the overall mass spectrometry imaging time. Preferably, the carrier gas flow should include helium to cool the desorbed nanoparticles. The range of sample movement is such that it allows analysis of the entire surface of a standard 25 mm by 75 mm microscope slide within the ablation chamber; however, other sizes are possible. To enable spatial resolution on the subcellular level in addition to a wide range of movement, the positioning accuracy of the sample movement below 1 μm should be assured.

The main advantage of the proposed system compared to the conventional LA ICP is in the detection of very low numbers of nanoparticles (units to thousands). The time required for analysis of a plume generated by a laser pulse will depend on the washout time of the laser ablation chamber, the transit time of the plume aerosol to and through the ICP, and the time taken to analyze the generated ions. As the disintegration of nanoparticles in plasma generates 200-600 μs wide spikes, one needs 10-100 ms per pixel to allow spike counting without significant particle coincidence (to achieve adequate “peak capacity” in an analogy to chromatography). Although washout times longer than 100 ms allow the resolution of multiple individual nanoparticle spikes from a single spot, they prolong the overall analysis time as the plumes from two consecutive spots should not overlap or should overlap minimally (<5%). Short washout times (<10 ms) increase the probability of particle coincidence and may lead to a negative error, i.e. number of generated spikes is lower than the number of nanoparticles. However, particle coincidence is not probable in the case of a very low number of nanoparticles in the irradiated spot. Also, in the case of too many nanoparticles of the same type in the irradiated spot, resolving the individual spikes is not required as the proportional response is high enough to be detected and integrated to provide an approximate number of nanoparticles. The number of nanoparticles on a pixel can be estimated even in this case by dividing the integrated response from a pixel by a single nanoparticle spike area determined from the nanoparticle signal histogram of the entire image. The preceding considerations are valid for the preferable mode of SP ICP MS detection, real-time acquisition (<100 μs dwell time).

Overall, laser pulse frequency and target movement (laser beam scan) should match the washout of the ablation chamber to prevent or minimize overlaps of the plumes from nanoparticles of the same type in general and overlaps of the plumes from consecutive laser spots in the imaging applications.

For the quantitation applications, a short washout time is not crucial as the plumes from consecutive laser spots may overlap. In fact, a long washout time may decrease particle coincidence at low particle frequencies. General ablation cells for a standard 25 mm by 75 mm (or similar) microscope slide that can accommodate tens or hundreds of samples can be used. In addition, ablation cells compatible with the standard 96 or 384 well plates can be used. In this case, the ablation cell is preferably formed by a well selected on the well plate and a cap that accommodates the inlet and outlet for carrier gas, the window for the laser beam, and the sealing o-ring. An XYZ-stage is used for selecting the particular well, closing, and sealing the ablation chamber, and scanning within the selected area on the bottom of the particular well. Thus, the immunosorbent assays can be compatible with commercially available 96 or 384 well plate format.

### Counting Applications (e.g. Quantitation Applications, Imaging Applications), Examples Thereof

Examples of the quantitation applications may be sandwich assays with a capture antibody and a detection antibody labeled with a nanoparticle tag or a sandwich assay with a capture antibody, a primary detection antibody, and secondary detection antibody labeled with a nanoparticle tag. These particle-linked immunosorbent assays (PLISA) are an analogy to sandwich enzyme-linked immunosorbent assays (ELISA), a nanoparticle is attached to the detection antibody instead of an enzyme. As individual nanoparticles can be detected by LA ICP MS, no amplifying reaction catalyzed by the enzyme is needed. This scheme can be used for direct trace detection of specific antigens, such as proteins, nucleic acids, viruses, and bacteria. The primary antibody is immobilized typically on a polymer and incubated with the antigen. After adding detection antibody or antibodies with nanoparticle tags and washing unbound antibody probes, the area with adsorbed probes is scanned with the laser, and nanoparticles are counted. The polymer can be directly desorbed with an IR laser, such as 2940 nm or in the 3200-3500 nm region or an absorbing compound may be added to facilitate the desorption of nanoparticles with another laser.

### Mass Spectrometer

The mass spectrometer should be capable of rapid data acquisition necessary for operation in the single-particle mode, i.e., capable of detecting spikes from the decomposition of single particles in the plasma torch. This means the signal integration time less than or equal to 10 ms (so-called “integration data acquisition mode”), or, preferably, in the range of 1-100 μs (so-called “real-lime data acquisition mode”) allowing reconstruction and integration of individual nanoparticle spikes. On the other hand, the response characteristics of the MS detection system should permit the determination of an integrated signal from the overlap of individual plumes in the case of a high concentration of nanoparticles of the same type on the irradiated spot. In the case of high nanoparticle concentrations, the employed mass spectrometers can operate in the regular, proportional mode.

The mass spectrometer can include all common mass analyzers. Preferably, it should be capable of detecting multiple (100-150) isotopes simultaneously in a single nanoparticle (i.e., also capable of determining the ratios of isotopes/elements in multi-isotope/multi-element nanoparticle, such as TOF, magnetic sector (e.g., multi-collector in the Mattauch-Herzog geometry) or possibly FT mass analyzers. The first two of these instruments are commercially available nowadays. ICP TOF mass spectrometer is sometimes termed mass cytometer. For certain experiments, mass spectrometers enabling detection of a single isotope, such as quadrupole or triple quadrupole may be used as well. State-of-the-art ICP mass spectrometers allow the detection of a gold nanoparticle with a diameter of 6-10 nm nowadays.

In one aspect, the invention provides a device for use in the method of the invention, which contains a multi-well plate movably positioned on an XY stage, and further contains a cap movably attached to a Z-stage via an arm, wherein the cap is configured to be pushed down against a well of the multi-well plate to form a sealed laser ablation chamber, and wherein the cap is provided with a gas inlet and a gas outlet, and with a window transparent for a laser beam. In some embodiments, the cap may be provided with a layer of a sealing material on its bottom surface, which ensures the sealing. Due to the positioning on an XY stage, the multi-well plate may move, and the cap may be sealed against various wells of the plate, thus allowing to analyze the contents of these wells. The cap is raised and lowered towards the wells due to its movability along the Z axis.

### BRIEF DESCRIPTION OF DRAWINGS

The figures and examples described below are for illustration purposes only and should not be construed as limiting the scope of protection.

FIG. 1 shows schematically the principle underlying the invention (FIG. 1b) in comparison with the prior art (FIG. 1a) as described in Example 1.

FIG. 2 shows the results of the measurement according to Example 2. (a) LA SP ICP MS image of a 3D cell aggregate section stained with Ki-67 antibody-20 nm Au nanoparticle conjugates (biotinylated antibody with streptavidin-coated nanoparticle). The degree of shade in the sidebar indicates the number of nanoparticles per pixel. Pixel size 15 μm, spheroid size ~1 mm, section thickness 8 μm. Laser wavelength 2940 nm, laser fluence 9.3J/cm² , laser frequency 20 Hz, laser spot size 20 μm, scan speed 150 um/s. (b) Histogram of summed spike counts (spike area) with a fitted log-normal distribution curve. (c) Signal transient (m/z 197) from row #55 with spikes of 190 nanoparticles and (d) from a pixel (column #120, row #55) with spikes of 3 nanoparticles.

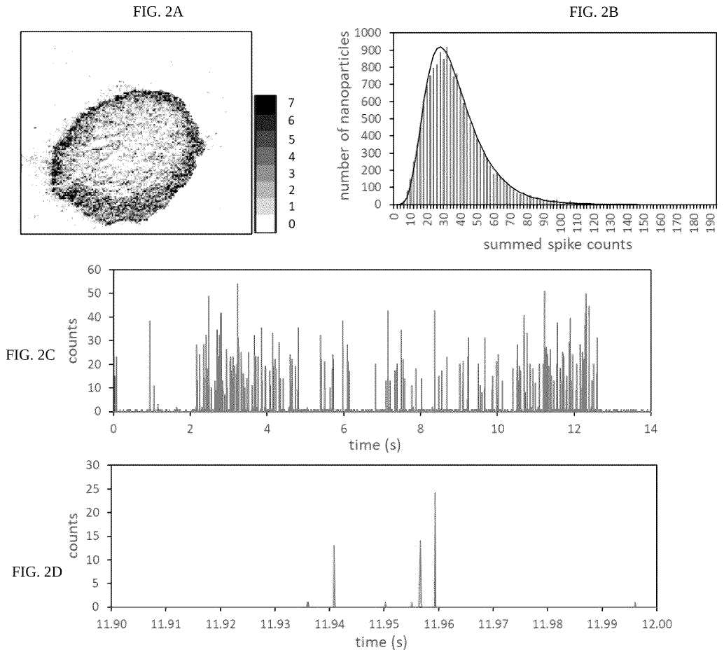

FIG. 3 shows the results of the measurement according to Example 3. (a) LA SP ICP MS image of a 3D cell aggregate section stained with Ki-67 antibody-40 nm Au nanoparticle conjugates (biotinylated antibody with streptavidin-coated nanoparticle). The degree of shade in the sidebar indicates the number of nanoparticles per pixel. An absorbing component IR 1050 was sprayed over the sample at 0.19 mg/mm². Pixel size: 20 μm, spheroid size ~1.4 mm, section thickness 12 μm. Laser wavelength 1064 nm, laser fluence 21 J/cm², laser frequency 500 Hz, laser spot size 40 μm, scan speed 200 μm/s. The degree of shade in the sidebar indicates the number of nanoparticles per pixel. (b) Histogram of summed spike counts (spike area) with a fitted log-normal distribution curve. (c) Signal transient (m/z 197) from row #34 with spikes of 121 nanoparticles and (d) from a pixel (column #91, row #34) with spikes of 3 nanoparticles.

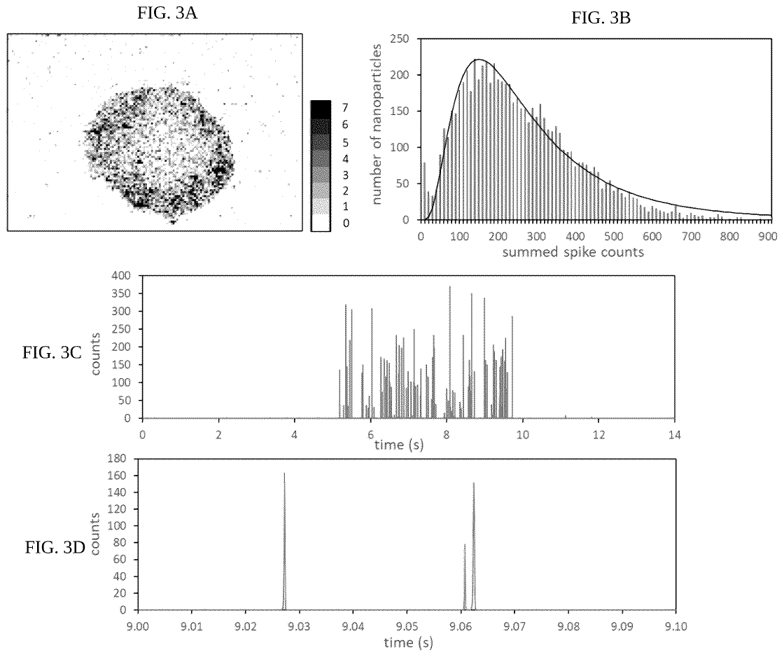

FIG. 4 shows images of 3D cell aggregate sections stained with Ki-67 antibody-20 nm Au NPs from (a, b) UV LA ICP MSI and (c) IR LA SP ICP MSI according to Example 4. The panels (a) and (b) display the same data on full and zoomed ion signal scale (shown on the sidebars), respectively. Here, the data was acquired in a common analogous mode as NPs were disintegrated. Hence, the degrees of shade in the sidebars do not correspond to the numbers of nanoparticles. The data on panel (c) was acquired in digital mode and the degree of shade in the sidebar indicates the number of nanoparticles per pixel. Also note the reduced background from bare glass slide around the spheroid; NPs are not desorbed due to the absence of organic tissue. Panel (d) shows UV LA ICP MS signal transient (m/z 197) from row #72 of the images on panels (a, b). Panel (e) shows IR LA ICP MS signal transient (m/z 197) from row #73 of the image on panel (c). Note the signal increase due to characteristic nanoparticle spikes and reduced noise on panel (e) compared to signal from conventional UV LA on panel (d).

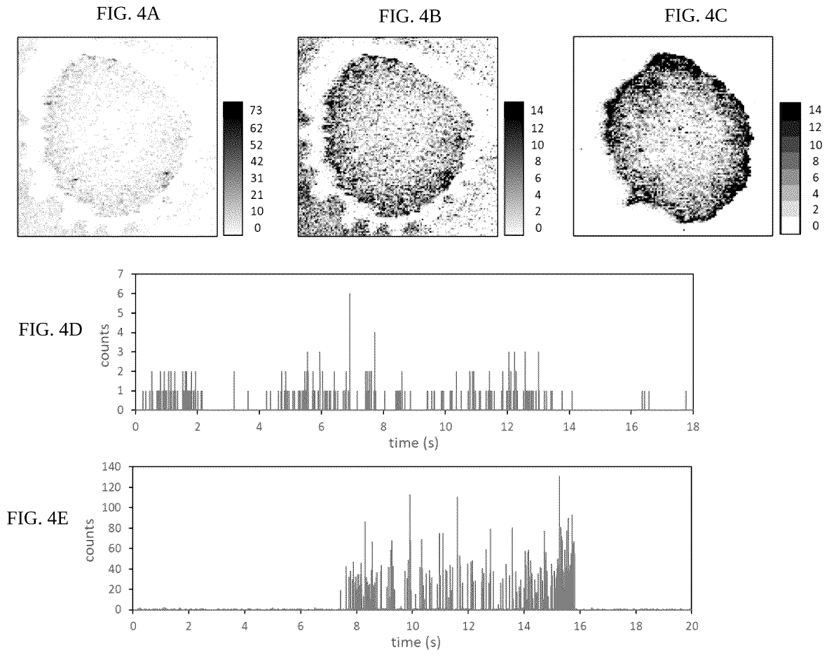

FIG. 5 shows the PLISA of Sars-CoV-2 S1 protein (antigen) obtained as described in Example 5. (a-d) LA SP ICP MS images of four square nitrocellulose spots with addition of 40 μL of antigen solution at concentration 0, 0.68, 1.37 and 2.73, respectively. The degree of shade in the sidebar indicates the number of nanoparticles per pixel. The numbers of counted nanoparticles in the capture antibody region denoted by circles are 1132, 2371, 4108, and 7194, respectively. Imaged area 2.55×2.01 mm², pixel size 15 μm. (e) Histogram of summed spike counts (spike area) with a fitted log-normal distribution curve for the spot shown on panel (d). (f) Calibration dependence of nanoparticle number vs. antigen concentration.

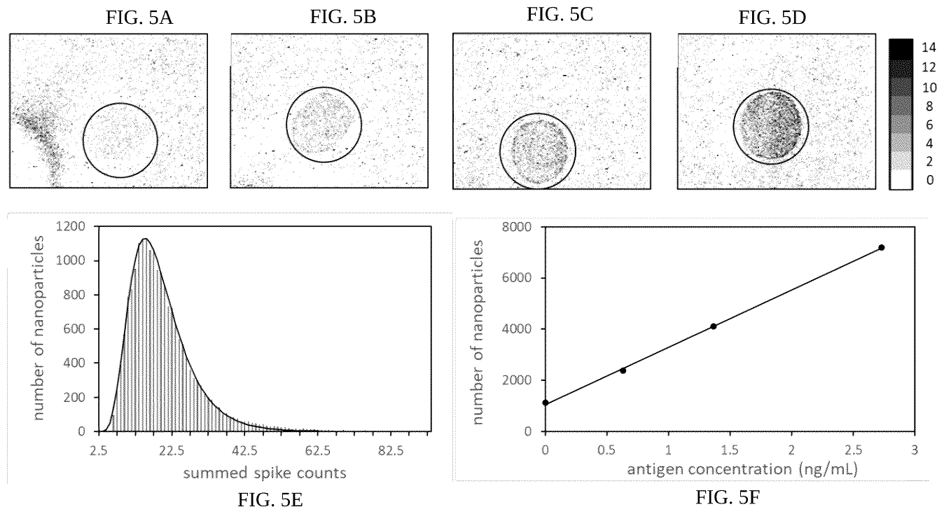

FIG. 6 shows a design of a laser ablation system for PLISA using LA SP ICP MS from multi-well plates serving as the support for multiple samples as described in Example 6.

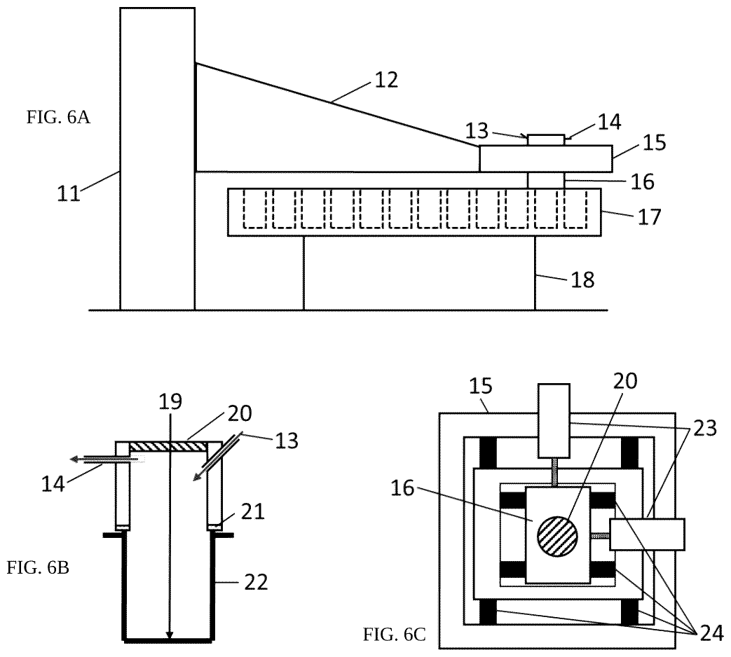

### EXAMPLES

### Example 1

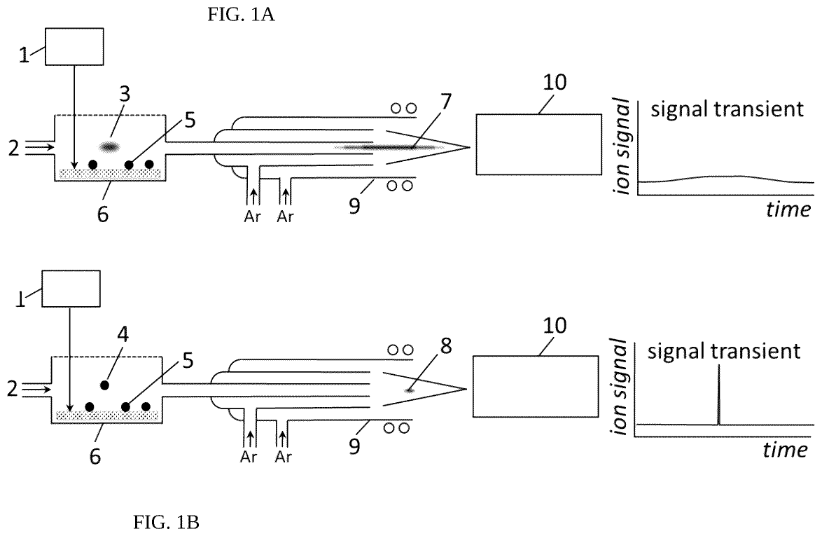

The principle underlying the invention is schematically shown in FIG. 1b, and compared with conventional systems shown in FIG. 1a. In LA ICP MS, the laser beam 1 is focused on a sample with nanoparticle tags 5 inserted in the ablation chamber 6, products of laser ablation are transported in the stream of carrier gas 2 into plasma torch 9 and generated ions are analyzed by the mass spectrometer 10. Conventional laser ablation with a pulsed UV laser (e.g., 193, 213, or 266 nm) in the absence of any absorbing component leads to a formation of a partial or complete disintegrated nanoparticle plume 3, which disperses 7 during transport to the plasma. Thus, some nanoparticles decompose fully and increase signal background and some nanoparticles decompose partially and cannot be correctly counted. For proper counting of nanoparticles, it is important to prevent the disintegration of nanoparticles prior to the plasma torch and to maximize the transport efficiency of nanoparticles. Using for example an IR laser, e.g., 2940 nm, 10 J/cm², or another laser, e.g., 1064 nm laser, 10 J/cm² for ablation of biological tissue or using a biological tissue with an absorbing component, such as IR 1050, 1-butyl-2-[2-[3-[(1-butyl-6-chlorobenz[cd]indol-2(1H)-ylidene)ethylidene]-2-chloro-5-methyl-1-cyclohexen-1-yl[ethenyl]-6-chlorobenz[cd]indolium tetrafluoroborate, respectively, intact nanoparticles 4 are transferred by the carrier gas 2, helium into the plasma torch 9 and the generated compact ion plume 8 is analyzed by the mass spectrometer 10. Sub-millisecond spikes in signal transient recorded at m/z 197 for gold ions can be clearly distinguished from the background and counted.

### EXAMPLE 2

### Spheroid Preparation

Human colorectal adenocarcinoma HT-29 cells (ATCC, HTB-38, LGC Standards, U.K.) were maintained in Dulbecco's Modified Eagle Medium (DMEM) supplemented with 10% fetal bovine serum (FBS) (Sigma-Aldrich, U.S. A), 2 mM L-glutamine (Eastport, Czech Republic), 100 U/mL penicillin and streptomycin (Lonza, Switzerland) in a humidified 5% CO₂ atmosphere at 37° C. For spheroid formation, the bottom of wells of a 12-well plate was covered with 1% agar in 1×PBS (Sigma-Aldrich) and HT-29 cells were seeded at a density of 50 000 cells per well in 1 mL of DMEM supplemented with 2 mM L-glutamine and lacking FBS. Cells were incubated on a rotary shaker (Orbital Shaker, NB-101SRC, N-BIOTEK, Korea) at 75 rpm in a humidified 5% CO₂ atmosphere at 37° C. for 3 hours, after which FBS was added to the final concentration of 10%, and the spheroids were cultivated for another 5 days at 60 rpm. After 5 days, DMEM medium was changed and subsequently supplemented with 10% FBS, 2 mM L-glutamine, 100 U/mL penicillin, and streptomycin, and spheroids were cultivated for another 5 days at 60 rpm in a humidified 5% CO₂ atmosphere at 37° C.

### Freezing and Sectioning of Spheroids

Grown spheroids were washed three times with 1×PBS and transferred to plastic cryomolds with Tissue-Tek® O.C.T™ Compound and snap frozen at −80° C. and stored temporarily in dry ice and permanently in a freezer at −80° C. Sectioning of blocks was performed in a cryostat Microtome CM1850 (Leica Microsystems, Germany) at −22° C., and 8 μm thick equatorial cross-sections were collected onto microscope glass slides by the thaw-mounting method.

### Immunohistochemical Staining

The next day, the spheroid sections were fixed in 4% formaldehyde (4° C., 20 min). Subsequently, sections were washed three times with cold 1×PBS Then, a washing step was followed by blocking with 100% SuperBlock™ (Sigma-Aldrich) for 30 min. The sections were incubated with a primary biotinylated antibody (clone SolA15) specific for Ki67 (cat. no. 13-5698-82), diluted 1:200 in 1×PBS containing 10% SuperBlock™, left overnight at 4° C. and washed three times with cold 1×PBS again. The gold nanoparticle streptavidin conjugate (Streptavidin Gold 20 nm, Cytodiagnostics, Canada) diluted to the final concentration of 15 ng/ml in 100% SuperBlock™ was applied for 2 hours at the room temperature. Then, another three washing cycles with cold 1×PBS, one extensive washing cycle in PBS at 50 rpm, and one cycle with Milli-Q water followed. The excess water was removed and samples were kept in the desiccator until used in the LA SP ICP MSI analysis.

### LA SP ICP MS

The samples were ablated using an IR ablation system consisting of an optical parametric oscillator (Opolette 2940, OPOTEK, Carlsbad, CA, USA) with 2 940 nm output radiation, 6 mJ peak energy, 5-7 ns pulse width, 20 Hz repetition rate and 5 mm beam diameter. To reach high imaging resolution, the beam was defocused by a beam expander consisting of an AR-coated CaF₂ plano-concave lens with 12.7 mm diameter and −25.0 mm focal length and an AR-coated CaF₂ plano-convex lens with 25.4 mm diameter and 100.0 mm focal length (Thorlabs, Newton, NJ, USA). Then the beam was reflected by a silver mirror (Thorlabs) at 45° in a cube and reduced by iris to a top hat-like beam profile with 1.0 mm diameter. Finally, the beam was focused on the sample by an AR-coated Black Diamond™ aspheric plano-convex lens with 8.0 mm diameter and 5.95 mm effective focal length (Edmund Optics, Barrington, NJ, USA) to 20 μm diameter at fluence 9.3J/cm^{2 .}

A glass microscope slide with the spheroid section was inserted into an aluminum ablation cell equipped with a fused silica window. The ablation cell was placed on XY-stage (Standa Ltd, Vilnius, Lithuania) which was controlled by a laboratory-developed application written in LabVIEW (National Instruments, Austin, TX, USA) environment. Line ablation trajectories with a length of ~2 mm in a fly-back mode with 15 μm spacing and 150 μm/s scan rate were set for desorption of tissue from the glass, corresponding to 15 μm pixel size. The dimensions of the rectangular channel above the center of the microscope slide were 4.7×3.0×76.1 mm (width×height×length). The ablation cell was washed by helium carrier gas at a flow rate of 1.6 L/min to reach a cell washout time of~85 ms.

The ablation cell was connected to the plasma torch of the ICP mass spectrometer (Agilent 7900, Agilent, Santa Clara, CA, USA) using 1.34 mm ID stainless steel capillary transfer tube (Swagelok, Solon, OH, USA) via a low-volume laser ablation adapter (31-808-4034, Glass Expansion, Port Melbourne, Australia) enabling the axial introduction of dry aerosol to Ar make-up gas flow with 0.4 L/min⁻¹ flow rate. Stainless steel capillary was used to minimize nanoparticle adsorption on the inner side of the tube. A signal at m/z 197 was recorded separately for each line with an acquisition time of ~20 s at an integration time of 100 μs. A plasma torch position and ion optics voltage were optimized using Au 1 ppb standard solution (Analytika, Prague, Czech Republic) to achieve the highest response of the detector at m/z 197.

### Data Processing

Data were processed using a devoted program developed in LabVIEW. The main functionalities of the software are rendering of intensity map, nanoparticle count map, and spectrum's intensity of line or pixel and histogram for analysis of spike count and spike area. In the nanoparticle count map, pixel shades of grey represent specific counts of nanoparticles.

First, input data were filtered on the base of the specified threshold and minimal spike width. All spikes were found; position on the time axis, amplitude, area, and width were determined for each spike. If a spike was wider than the maximum spike width parameter, the spike was split into several segments with the maximal peak width in the time axis; the segments were evaluated independently as individual spikes. In the case signal exceeded the threshold for a long period and the spike extended over neighbor pixels, the nanoparticle count was not assigned only to a single pixel associated with the spike maximum but was distributed over more neighbor pixels. The spike area histogram was constructed, fitted with log-normal distribution, and its mode was determined. The nanoparticle count in each spike was determined from the ratio between the spike area and the most probable spike area (the mode) determined from the spike area histogram. Finally, the nanoparticle count is assigned to the specific pixel based on the time position of the spike. For 20 nm gold nanoparticles, the parameters for the spike detection were: threshold 2 counts, minimal spike width: 3 pts, maximal spike width: 7 pts.

### EXAMPLE 3

### Sample Preparation

Spheroids were prepared, sectioned and immunostained as described in Example 2, section thickness was 12 μm. Afterwards, 2 mg/mL solution of absorbing component IR 1050, 1-Butyl-2-[2-[3-[(1-butyl-6-chlorobenz[cd]indol-2(1H)-ylidene)ethylidene]-2- -chloro-5-methyl-1-cyclohexen-1-yl]ethenyl]-6-chlorobenz[cd]indolium tetrafluoroborate (Sigma-Aldrich cat. no. 405124) in acetonitrile was sprayed over the sample yielding coverage 0.19mg/mm².

### LA SP ICP MS

The samples were ablated using an ablation system consisting of a laser (MPL-H-1064, Laser Export, Russia) with 1 064 nm output radiation, max. 0.1 mJ energy per pulse, 5-10 ns pulse width, and 1.5 mm beam diameter. The laser beam was directed via a pair of mirrors to a beam expander (GBE05-B, Thorlabs, USA) and then via a dichroic mirror at 45° in a cube and focusing aspheric lens with antireflection coating, focal length 8.4 mm (67245, Edmund Optics, USA) to the sample. The laser spot size was 40 μm, repetition rate 500 Hz, and fluence 21 J/cm².

A glass microscope slide with the spheroid section was inserted into an aluminum ablation cell of the same design as in Example 2. Line ablation trajectories with a length of 3 mm in a fly-back mode with 20 μm spacing and 200 μm/s scan rate were set for desorption of tissue from the glass, corresponding to 20 μm pixel size. The ablation cell was washed by helium carrier gas at a flow rate of 1.6 L/min to reach a cell washout time of~100 ms. The dry aerosol from the cell was mixed with 0.4 L/min of argon make-up gas via a Y-quick fitting coupler and carried to an ICP mass spectrometer (Agilent 7900, Agilent). Perfluoroalkoxy alkane tube (VWR International, Radnor, PA, USA) with 4.0 mm inner diameter connecting the ablation cell with the mass spectrometer was used to minimize nanoparticle absorption on the inner side of the tube.

The optimization and settings of the ICP MS were the same as in Example 2, except the signal at m/z 197 was recorded separately for each line with an acquisition time of 30 s.

### Data Processing

Data were processed using the same software as in Example 2. For 40 nm gold nanoparticles, the parameters for the spike detection were: threshold 10 counts, minimal spike width: 3 pts, maximal spike width: 5 pts.

### EXAMPLE 4

### Sample Preparation

A 3D cell aggregate was prepared, sectioned and immunostained as described in Example 2. For UV LA ICP MS and IR LA SP ICP MS, adjacent section from the same spheroid of the human colorectal adenocarcinoma cell line HT-29 labeled with Ki-67 antibody—20 nm Au NPs were used.

### UV LA ICP MS

A glass slide with spheroid sections was inserted into a UV laser ablation system (LSX-213 G2+, Teledyne Photon Machines Inc, Omaha, NE, USA) equipped with 213 nm Q-switched Nd:YAG laser with maximal pulse energy >4 mJ, pulse width <5 ns, repetition rate 20 Hz, and HelEx II Active 2-Volume Cell with washout time <20 ms. The samples were scanned in the line fly-back mode. The parameters of ablation and acquisition including optimization were the same as in the case of the IR ablation in Example 2 except fluence 4.0J/cm² , He gas flow—cell 0.6L.min⁻¹ , He gas flow—funnel 0.3 L.min⁻¹ and Ar auxiliary gas flow 0.4L.min⁻¹ . The data acquisition and processing were the same as described in Example 2.

### IR LA ICP MS

The glass slide with the adjacent section from the same spheroid was used in this experiment. The procedure including all experimental conditions, data acquisition, and data processing were the same as described in Example 2.

### EXAMPLE 5

### Sample Preparation

A glass slide with nitrocellulose square spots (Nova, Grace Bio-Labs, USA) was placed on a metal block cooled to −20° C., the humidity of the air was 70%. Droplets containing 50 nL 1 mg/mL solution of capture antibody specific for RBD (receptor binding domain) of S1 protein from SARS CoV-2 (E-EL-605 KIT, Elabscience, USA) were applied using a micropipette on square spots. Immediately thereafter, the slide with deposited droplets was stored in a refrigerator at 4° C. to allow drying of the droplets overnight. The next day, a Proplate mask (Grace Bio-Labs) was attached to the slide to separate the spots from each other. The dried spots with adsorbed dried antibody were incubated with 40 μL of 50% SuperG Block solution (Grace Bio-Labs) in 1×PBS without shaking at laboratory temperature for 1 hour. The solution was then poured off and washed 1× with 50 μL 1×PBS. The standard of RBD S1 protein (E-EL-605 kit, Elabscience), just “antigen” hereafter, was added to each well at concentrations from 0.65 ng/ml to 5.46 ng/ml in the volume of 40 μL in the solution provided in the E-EL- 605 kit (Elabscience). Parafilm was pulled over the wells to prevent evaporation and the entire slide with a mask was placed on a shaker at 37° C. for 1.5 hours. After incubation, the solution was removed from the wells and 800× diluted biotinylated detection antibodies specific for RBD of S1 protein from SARS CoV-2 from the E-EL-605 kit (Elabscience) were added without washing. Again, parafilm was pulled over the wells, and the slide with the mask was placed in a shaker at 37° C. for 1 hour. After incubation, the solution in the wells was removed and the wells were 3× washed with 50 μL 1×PBS. Subsequently, gold nanoparticle streptavidin conjugate (Streptavidin Gold 20 nm, Cytodiagnostics, Canada) with a total concentration of 2.5×10¹⁰ nanoparticles/mL was added in a volume of 40 μL. The wells were covered with parafilm and incubated in a shaker at 37° C. for 30 min. The liquid was then removed from the wells and washed 5× with 50 μL 1×PBS. Residual liquid was mechanically completely removed and the remaining wet spots were allowed to dry. After drying, the mask was removed from the slide and the slide was placed in the refrigerator.

### LA SP ICP MS

The samples were ablated using an IR ablation system described in Example 2, a glass slide with nitrocellulose square spots was inserted into the aluminium ablation cell. The dimensions of the rectangular channel above the microscope slide were modified to 25.0×3.0×76.1 mm³ (width×height ×length) to allow ablation from the entire slide area. Line ablation trajectories with a length of 2.55 mm in a fly-back mode with 15 μm spacing and 150 μm/s scan rate were adjusted, resulting pixel size was 15 μm. The overall dimensions of the scan were up to 2.55×2.55mm² . The fluence of the laser beam was 11.8 J/cm² and the repetition rate was 20 Hz. The connections between the ablation cell and the plasma torch of the mass spectrometer were the same as in Example 2, except that the helium carrier gas flow rate was 1.2 L/min.

Optimization of the plasma torch position and ion optics voltage, including the acquisition of signal at m/z 197, was performed as in Example 2.

### Data Processing

Data were processed using the same program as in Example 2. For 20 nm gold nanoparticles, the parameters for the spike detection were: threshold 2 counts, minimal spike width: 3 pts, maximal spike width: 7 pts. For quantitation purposes, the program allowed the selection of a region in the image where the capture antibody was deposited. Nanoparticle numbers were determined from this user-selected region for all nitrocellulose spots; the area of the selected region was the same for all spots. Calibration was constructed as the dependence of nanoparticle number in the selected region vs. antigen concentration.

### EXAMPLE 6

Design of laser ablation system for PLISA using LA SP ICP MS from multi-well plates serving as the support for multiple samples. Each well of the multi-well plate contains a sample with nanoparticle tags immobilized on support prepared according to Example 5. Integration of the laser ablation system to the SP ICP MS, i.e., carrier gas inlet 13 and outlet 14, are indicated. The laser ablation chamber consists of two separate pieces: a cap 16 held by a head 15 positioned on a Z-stage 11 using an arm 12 and a well selected from the multi-well plate positioned on an XY-stage 18. The laser ablation chamber is closed via a sealing 21 by pushing the cap down against the selected well. (a) Side view of the overall laser ablation system for PLISA with a 96-well plate 17. (b) Detail side view of the laser ablation chamber formed by the cap 16 and the selected well 22. The cap is furnished with a window 20 for the laser beam 19 and carrier gas inlet 13 and outlet 14. (c) Top view of the head 15 with the cap 16 on XY-guides 24 and two arresting electromagnets 23.

First, the XY-stage is used to select the well for LA SP ICP MS. The Z-stage lowers the head with the cap arrested e.g., by a pair of electromagnets in the center position on the XY-guides to seal the ablation chamber. After the cap is pushed down to the selected well, the electromagnets release the cap in the head and the XY-stage is employed to scan the laser beam within the bottom of the selected well-the support with immobilized nanoparticle tags. Thus, the single XY-stage can be used for both well selection and laser beam scan. The cap is equipped with a window for the laser beam and with an inlet and outlet for carrier gas allowing transport of desorbed nanoparticle tags.

1. A method of counting inorganic nanoparticle tags in a sample, using laser ablation inductively coupled plasma mass spectrometry (LA ICP MS), comprising the steps of:
a) providing a sample containing inorganic nanoparticle tags, said sample having at least one absorbing component capable of absorbing energy of a laser at least one predetermined wavelength,
b) irradiating a spot in the sample by a laser emitting at the at least one predetermined wavelength, thereby exciting and ablating the absorbing component on the illuminated spot, thereby causing desorption of the inorganic nanoparticle tag(s) which are present in the irradiated spot without disintegrating the inorganic nanoparticle tag(s), and
c) transferring the desorbed inorganic nanoparticle tag(s) into an ICP torch, subjecting it to inductively coupled plasma mass spectrometry, and detecting spike(s) of the individual inorganic nanoparticle tag(s).

2. The method according to claim 1, wherein at all predetermined wavelengths the inorganic nanoparticle tag(s) do not absorb which prevents their decomposition and formation of a plume.

3. The method according to claim 1, wherein the nanoparticle tags consist of one metal and/or one metal salt and/or metal oxide, or of a mixture of metals and/or metal salts and/or metal oxides, or of one metal isotope and/or one metal isotope salt and/or metal isotope oxide, or of a mixture of metal isotopes and/or metal isotope salts and/or metal isotope oxides.

4. The method according to claim 3, wherein the metals contained in the nanoparticle tags have atomic masses within the atomic mass range 80-250.

5. The method according to claim 1, wherein the at least one predetermined wavelength is in the range of 157 nm to 50 μm.

6. The method according to claim 1, wherein the absorbing component is an auxiliary absorbing component selected from organic dyes, suspensions of graphite and/or metal, and polymers.

7. The method according to claim 1, wherein the absorbing component is an auxiliary absorbing component selected from cyanines, indoles, dienylidens, rhodamines, fluoresceins, coumarins, polyethylene terephthalate glycol, polyethylene terephthalate, polystyrene, polyacrylates, polycarbonates, nitrocellulose, cellulose.

8. The method according to claim 6 wherein the auxiliary absorbing component is in the form of a slide on which the sample is placed.

9. A device, comprising:
a multi-well plate (17) movably positioned on an XY stage (18), and
a cap (16) movably attached to a Z-stage (11) via an arm (12), wherein the cap (16) is configured to be pushed down against a well of the multi-well plate (17) to form a sealed laser ablation chamber configured to contain the desorbed inorganic nanoparticle tag(s), and wherein the cap (16) is provided with a gas inlet (13) and a gas outlet (14) configured to transfer the desorbed inorganic nanoparticle tag(s) into an ICP torch, and with a window (20) transparent for a laser beam (19).

10. The method according to claim 1, wherein the at least one predetermined wavelength is in the range of 500 nm to 50 μm.

11. The method according to claim 1, wherein the at least one predetermined wavelength is in the range of 1 to 3.5 μm.

12. The method according to claim 8, wherein the auxiliary absorbing component is a polymer.
